(19) United States
(12) Patent Application Publication
(10) Pub. No.: US 2026/0342606 A1
(43) Pub. Date: Oct. 29, 2026

(54) METHODS FOR BROADCASTING AND AIML DISCOVERY IN WLAN

(71) Applicant: InterDigital Patent Holdings, Inc., Wilmington, DE (US)

(72) Inventors: Xiaofei WANG, North Caldwell, NJ (US); Joseph LEVY, Merrick, NY (US); Zinan LIN, Basking Ridge, NJ (US)

(73) Assignee: InterDigital Patent Holdings, Inc., Wilmington, DE (US)

(21) Appl. No.: 19/128,046

(22) PCT Filed: Nov. 10, 2023
(86) PCT No.: PCT/US2023/079338

§ 371 Date: May 7, 2025

Related U.S. Application Data
(60) Provisional application No. 63/424,578, filed on Nov. 11, 2022.
(60) Provisional application No. 63/431,540, filed on Dec. 9, 2022.

(51) Int. Cl. H04L 12/18; H04W 28/18; H04W 72/30; H04W 84/12

(52) U.S. Cl. CPC H04L 12/189; H04W 28/18; H04W 72/30; H04W 84/12

(57) ABSTRACT

Methods and apparatuses are described for broadcasting and Artificial Intelligence and Machine Learning (AIML) discovery in a wireless local area network (WLAN). A method for use in a station (STA) is described, the method may include receiving an Enhanced Broadcast Services (EBCS) termination notice from an EBCS access point (AP) for one or more ECBS traffic streams transmitted by the AP; determining that the termination notice indicates an EBCS traffic stream of shorter duration than desired by the STA; and transmitting, by the STA to the EBCS AP, when the STA is associated with the AP and the termination notice indicates a negotiation method type 1 or type 2 is permitted, an EBCS content request frame requesting extension of the EBCS traffic stream. In further embodiments the EBCS content request frame includes a desired value in a requested time to termination subfield of the EBCS content request.

### CROSS REFERENCE TO RELATED APPLICATIONS

This application claims priority to and incorporates by reference in their entirety the following United States provisional applications: Application Number 63/424,578, filed on Nov. 11, 2022 and titled Methods for Broadcasting and AIML Discovery in WLAN; and Application Number 63/431,540, filed on Dec. 9, 2022 and titled Methods for Broadcasting and AIML Discovery in WLAN.

### BACKGROUND

Enhanced broadcast service (EBCS) may refer to a medium access control (MAC) amendments for IEEE 802.11 devices. EBCS service may be downlink from an access point (AP) to non-AP stations (STAs) or may be uplink from non-AP STAs. An AP may be expected to support up to 3,000 non-AP STAs with EBCS service. In downlink broadcasting, EBCS APs provide broadcasting services to STAs that are either associated with it or unassociated with the APs. EBCS STAs need to discover which EBCS APs provide EBCS services. In addition, EBCS AP and STAs need to negotiate for providing and receiving the EBCS traffic streams. Thus, methods and apparatuses that efficiently discover and negotiate for such services are needed.

### SUMMARY

A method for use in a station (STA) is described, the method comprising: receiving an Enhanced Broadcast Services (EBCS) termination notice from an EBCS access point (AP) for one or more ECBS traffic streams transmitted by the AP; determining that the termination notice indicates an EBCS traffic stream of shorter duration than desired by the STA; and transmitting, by the STA to the EBCS AP, when the STA is associated with the AP and the termination notice indicates a negotiation method type 1 or type 2 is permitted, an EBCS content request frame requesting extension of the EBCS traffic stream. In further embodiments the EBCS content request frame includes a desired value in a requested time to termination subfield of the EBCS content request. In further embodiments, the EBCS content request frame comprises a content ID subfield corresponding to the EBCS traffic stream. In further embodiments, a type 1 negotiation method includes a request through EBCS content request frames. In further embodiments, a type 2 negotiation method incudes a request through an EBCS content request frame or a request through an EBCS content request ANQP element.

A further method for use in a STA is described, the method comprising: receiving an EBCS termination notice from an EBCS AP for one or more ECBS traffic streams transmitted by the AP; determining that the termination notice indicates an EBCS traffic stream of shorter duration than desired by the STA; and transmitting, by the STA to the EBCS AP, when the STA is not associated with the AP and the termination notice indicates a negotiation method type 2 is permitted, an EBCS content request frame including an access network query protocol (ANQP) element requesting extension of the EBCS traffic stream. In a further embodiment, the ANQP element includes a desired value in a requested time to termination subfield of the EBCS content request. In a further embodiment, the EBCS content request frame comprises a content ID subfield corresponding to the EBCS traffic stream. In a further embodiment, a type 2 negotiation method includes a request through an EBCS content request ANQP element.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a diagram illustrating an example enhanced broadcast service (EBCS) discovery procedure;

FIG. 3 is a diagram illustrating an example EBCS negotiation procedure;

FIG. 4 is a diagram illustrating a further example EBCS negotiation procedure.

### DETAILED DESCRIPTION

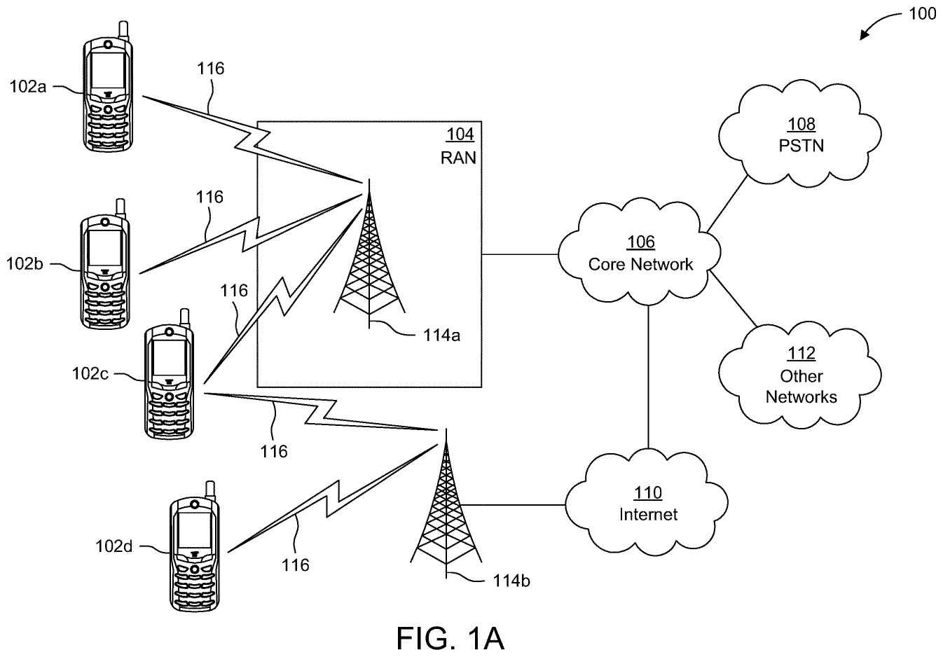

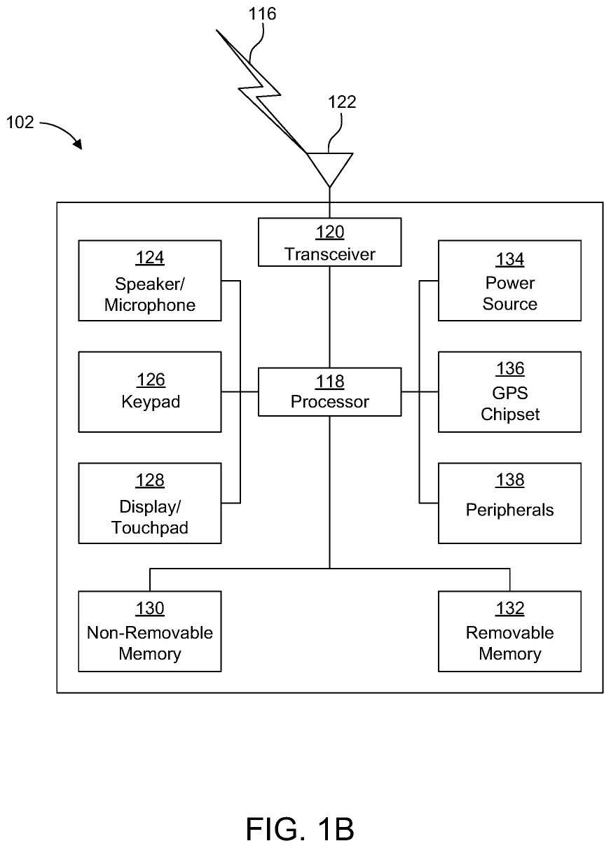

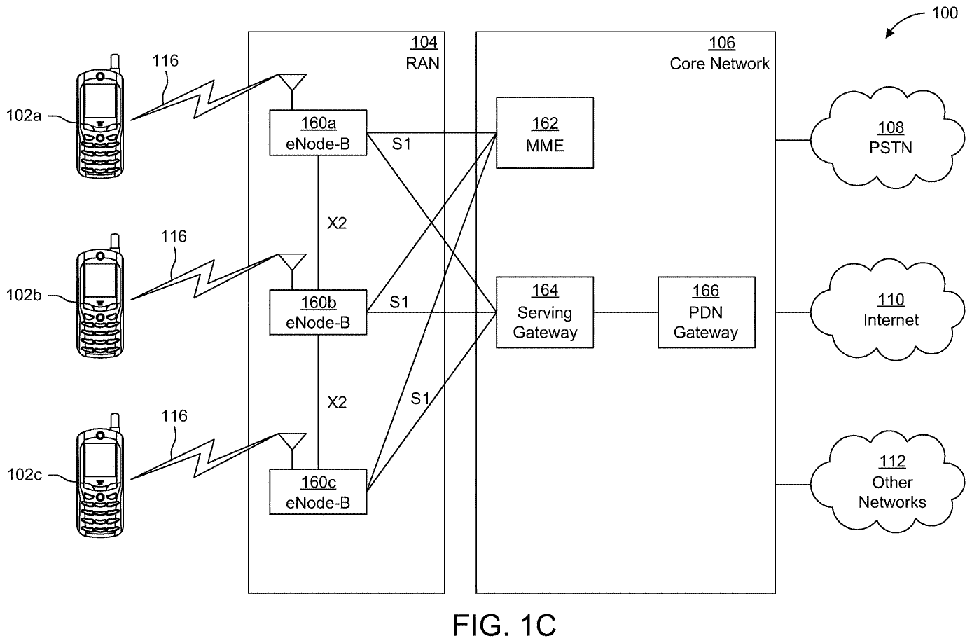

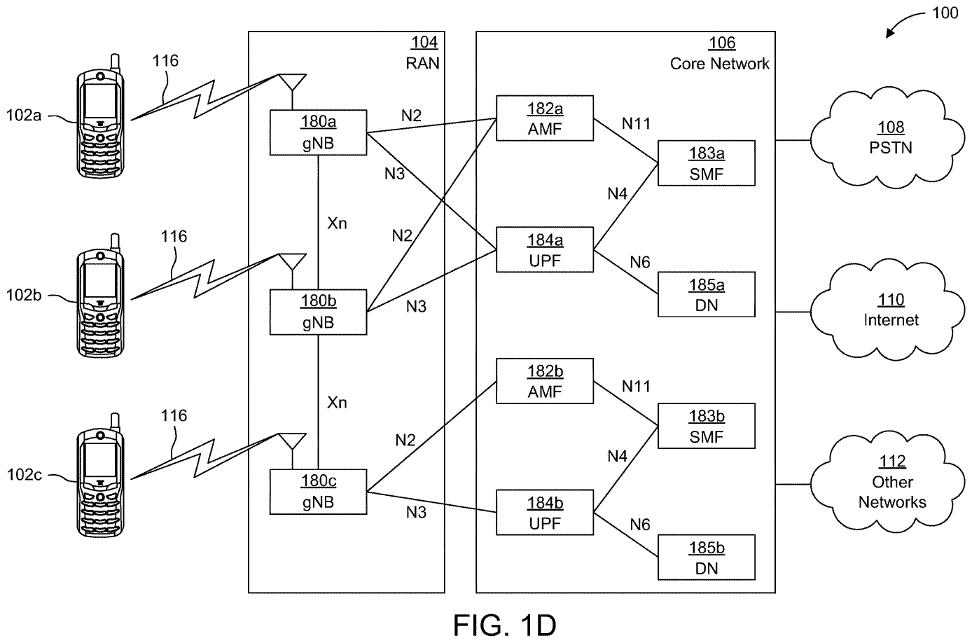

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous80 MHz channels, which may be referred to as an 80+80 configuration. For the 80 +80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A WLAN in Infrastructure Basic Service Set (BSS) mode has an Access Point (AP) for the BSS and one or more stations (STAs) associated with the AP. The AP typically has access or interface to a Distribution System (DS) or another type of wired/wireless network that carries traffic in and out of the BSS. Traffic to STAs that originates from outside the BSS arrives through the AP and is delivered to the STAs. Traffic originating from STAs to destinations outside the BSS is sent to the AP to be delivered to the respective destinations. Traffic between STAs within the BSS may also be sent through the AP where the source STA sends traffic to the AP and the AP delivers the traffic to the destination STA. Such traffic between STAs within a BSS is really peer-to-peer traffic. Such peer-to-peer traffic may also be sent directly between the source and destination STAs with a direct link setup (DLS) using an 802.11e DLS or an 802.11z tunneled DLS (TDLS). A WLAN using an Independent BSS (IBSS) mode has no AP, and/or STAs, communicating directly with each other. This mode of communication is referred to as an “ad-hoc” mode of communication.

Using the 802.11ac infrastructure mode of operation, the AP may transmit a beacon on a fixed channel, usually the primary channel. This channel may be 20 MHz wide, and is the operating channel of the BSS. This channel is also used by the STAs to establish a connection with the AP. The fundamental channel access mechanism in an 802.11 system is Carrier Sense Multiple Access with Collision Avoidance (CSMA/CA). In this mode of operation, every STA, including the AP, will sense the primary channel. If the channel is detected to be busy, the STA backs off. Hence only one STA may transmit at any given time in a given BSS.

In 802.11n, High Throughput (HT) STAs may also use a 40 MHz wide channel for communication. This is achieved by combining the primary 20 MHz channel, with an adjacent 20 MHz channel to form a 40 MHz wide contiguous channel.

In 802.11ac, Very High Throughput (VHT) STAs may support 20 MHz, 40 MHz, 80 MHz, and 160 MHz wide channels. The 40 MHz, and 80 MHz, channels are formed by combining contiguous 20 MHz channels similar to 802.11n described above. A 160 MHz channel may be formed either by combining 8 contiguous 20 MHz channels, or by combining two non-contiguous 80 MHz channels, this may also be referred to as an 80+80 configuration. For the 80+80 configuration, the data, after channel encoding, is passed through a segment parser that divides it into two streams. IFFT, and time domain, processing are done on each stream separately. The streams are then mapped on to the two channels, and the data is transmitted. At the receiver, this mechanism is reversed, and the combined data is sent to the MAC.

Sub 1 GHz modes of operation are supported by 802.11af, and 802.11ah. For these specifications the channel operating bandwidths, and carriers, are reduced relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. A possible use case for 802.11ah is support for Meter Type Control (MTC) devices in a macro coverage area. MTC devices may have limited capabilities including only support for limited bandwidths, but also include a requirement for a very long battery life.

WLAN systems which support multiple channels, and channel widths, such as 802.11n, 802.11ac, 802.11af, and 802.11ah, include a channel which is designated as the primary channel. The primary channel may, but not necessarily, have a bandwidth equal to the largest common operating bandwidth supported by all STAs in the BSS. The bandwidth of the primary channel is therefore limited by the STA, of all STAs in operating in a BSS, which supports the smallest bandwidth operating mode. In the example of 802.11ah, the primary channel may be 1 MHz wide if there are STAs (e.g., MTC type devices) that only support a 1 MHz mode even if the AP, and other STAs in the BSS, may support a 2 MHz, 4 MHz, 8 MHz, 16 MHz, or other channel bandwidth operating modes. All carrier sensing, and NAV settings, depend on the status of the primary channel; i.e., if the primary channel is busy, for example, due to a STA supporting only a 1 MHz operating mode is transmitting to the AP, then the entire available frequency bands are considered busy even though majority of it stays idle and available.

In the United States, the available frequency bands which may be used by 802.11ah are from 902 MHz to 928 MHz. In Korea it is from 917.5 MHz to 923.5 MHz; and in Japan, it is from 916.5 MHz to 927.5 MHz. The total bandwidth available for 802.11ah is 6 MHz to 26 MHz depending on the country code.

The IEEE 802.11bc may include a MAC amendment to enhanced broadcast service (EBCS) for 802.11 devices. The IEEE 802.11bc amendment will not impact the current IEEE 802.11 PHY specifications.

EBCS service may be downlink from an AP to non-AP STAs or may be uplink from non-AP STAs such as sensors or IoT devices. It is the intent that enhanced Broadcast Service is provided to both STAs that are associated or unassociated with a particular AP. An AP may support up to 3000 non-AP STAs with EBCS service. In addition, there may be a class of low-cost non-AP STAs that consumes the EBCS service may not be able to transmit directly to the AP.

Some usage cases for EBCS may include, but are not limited to: Stadium Video Broadcasting; Automotive broadcasting; Uplink Sensor Data Broadcasting; Museum Information and Multilingual Broadcasting; Event Producer Information and Content Broadcasting; Introduction of Machine Learning and Federated Learning; and Machine Learning.

The machine learning may be defined as a computer program that is said to learn from experience E with respect to some class of tasks T, and performance measure P, if its performance at tasks in T, as measured by P, improves with experience E. There are many different kinds of machine learning, depending on the nature of the task T the system will learn, the nature of the performance measure P used to evaluate the system, and the nature of the training signal or experience E given to it.

Machine learning implementations may be classified into three major categories, depending on the nature of the learning “signal” or “response” available to a learning system which is as follows:

Supervised learning: When an algorithm learns from example data and associated target responses that can consist of numeric values or string labels, such as classes or tags, in order to later predict the correct response when posed with new examples comes under the category of supervised learning. This approach is indeed similar to human learning under the supervision of a teacher. The teacher provides good examples for the student to memorize, and the student then derives general rules from these specific examples; and

Unsupervised learning: Whereas when an algorithm learns from plain examples without any associated response, leaving to the algorithm to determine the data patterns on its own. This type of algorithm tends to restructure the data into something else, such as new features that may represent a class or a new series of un-correlated values. They are quite useful in providing humans with insights into the meaning of data and new useful inputs to supervised machine learning algorithms.

In reinforcement learning, the system or agent has to learn how to interact with its environment. This can be encoded by means of a policy a=π(x), which specifies which action to take in response to each possible input x (derived from the environment state). The difference from supervised learning is that the system is not told which action is the best one to take (i.e., which output to produce for a given input). Instead, the system just receives an occasional reward (or punishment) signal in response to the actions that it takes. This is like learning with a critic, who gives an occasional thumbs up or thumbs down, as opposed to learning with a teacher, who tells you what to do at each step.

Federated Learning is a machine learning setting where the goal is to train a high-quality centralized model while training data remains distributed over a large number of clients each with unreliable and relatively slow network connection. The learning algorithms considered for this setting are on each round, each client may independently compute an update to the current model based on its location data, and communicate this update to a central server, where the client-side updates are aggregated to compute a new global update. The typical clients in this setting are mobile phones, and communication efficiency is of utmost importance. Federated Learning enables mobile phones to collaboratively learn a shared prediction model while keeping all the training data on device, decoupling the ability to do machine learning from the need to store the data in the cloud. The training data may be kept locally on users' mobile devices, and the devices are used as nodes performing computation on their local data in order to update a global model.

A simple implementation of Federated Learning may require that each client sends a full model (or a full model update) back to the server in each round. For large models, this step is likely to be a bottleneck of Federated Learning due to multiple factors. One factor is the asymmetric property of internet connection speeds: the uplink is typically much slower than downlink. Therefore, there are many ways to reduce the uplink communication (from the client to the server) cost in Federated Learning. For example, structured updates, where an update from a restricted pace can be learned and it can be parametrized using a smaller number of variables. In another example, sketched updates, where a full model is updated. Then it may be compressed before sending to the server.

In downlink broadcasting use cases, an EBCS AP may provide broadcasting services to STAs that are either associated with the AP or unassociated with the AP. EBCS STAs may need to discover which EBCS APs provide EBCS services. In addition, EBCS AP and STAs may need to negotiate for providing and receiving the EBCS traffic streams. Thus, methods and apparatuses how to efficiently discover and negotiate for such services are needed.

With the prevalence of AIML in many areas of technologies, it is expected that AIML technologies may be applied or carried in WLAN networks. Thus, methods and apparatuses how a STA can efficiently support and use AIML services after association or AIML service configuration and information exchange are needed.

Embodiments for efficient EBCS discovery and negotiations are described herein. In an embodiment for EBCS discovery, an AP that is not in a multiple BSSID set and has EBCSSupportActivated equal to true and a nonzero EBCSTrafficStreamTable length may include an EBCS Parameters element in the fast initial link setup (FILS) discovery frame that it transmits. In a multiple BSSID set, the AP corresponding to the transmitted BSSID that also has EBCSSupportActivted equal to true and a nonzero EBCS TrafficStreamTable length may include an EBCS Parameters element in the FILS Discovery frame it transmits.

An EBCS STA or receiver discovers an EBCS capable AP by receiving any of, but not limited to, the following frames: a Beacon frame, an S1G Beacon frame, a Probe Response frame or a PV1 Probe Response frame with the EBCS Support field in the Extended Capability element equal to 1, an EBCS Info frame, an ANQP Response frame that includes the EBCS ANQP-element, and an FILS Discovery frame that includes an EBCS Parameter element.

An EBCS STA or receiver is able to know when the next EBCS Info frame is transmitted by inspecting the EBCS Info Frame TX Countdown field in the EBCS Parameters element in received Beacon frames, S1G Beacon frames, Protocol Version 1 (PV1) Probe Response frames, and Probe Response frames, FILS Discovery frames, the Enhanced Broadcast Services ANQP element in ANQP Response frames or the like. An EBCS receiver may select the EBCS traffic streams to receive and consume.

An EBCS STA or receiver may then use the information discovered in the EBCS Info Frame TX countdown field received in beacon frames, S1G Beacon frames, Probe response frame or FILS Discovery frames to receive the EBCS Information frames. After receiving one or more EBCS Information frames, the EBCS STA or receiver may decide to request one or more EBCS traffic streams. The EBCS STA may then transmit EBCS Content Request to the EBCS AP to request one or more EBCS traffic streams. Alternatively or additionally, it may transmit EBCS Content Request ANQP-element to request one or more EBCS traffic streams depending whether the EBCS traffic stream requires association or not.

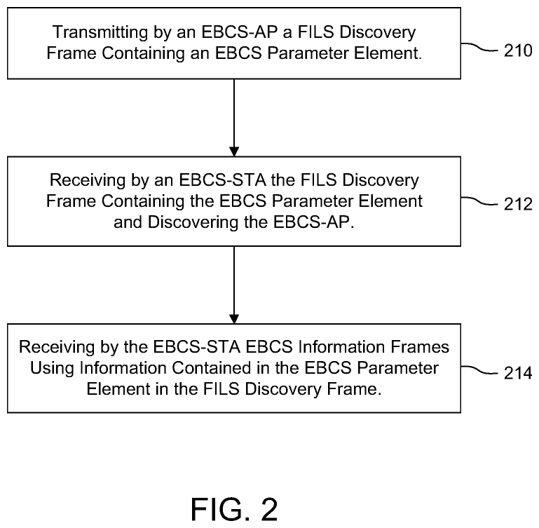

FIG. 2 is a diagram illustrating an example enhanced broadcast service (EBCS) discovery procedure. At 210 an EBCS-enabled AP transmits a FILS discovery frame containing an EBCS parameter element. At 212 an EBCS-enabled STA receives the FILS discovery frame, which contains the EBCS parameter element and discovers the EBCS enabled AP. At 214 the EBCS-enabled STA receives EBCS information frames using information contained in the EBCS parameter element in the FILS discovery frame.

Embodiments for an efficient EBCS negotiation procedure are described herein. An unassociated EBCS STA may transmit an EBCS ANQP-element to an EBCS AP to register for one or more EBCS traffic streams when that AP has indicated that it does not require an association. When registering for an EBCS traffic stream using an EBCS Request ANQP-element, an EBCS STA may request a specific time to termination using the Requested Time To Termination subfield and may indicate the MAC address of the AP it is currently receiving the service from using the Broadcaster MAC Address subfield. The Broadcaster MAC Address subfield may allow the non-AP STA to provide the MAC address of the AP currently serving the EBCS traffic stream, which may not be the same as the one receiving the request. This information may be used to distribute the EBCS load transmitted by different EBCS APs in a certain area.

After receiving an EBCS Request ANQP-element from an unassociated EBCS STA, an EBCS AP may respond with EBCS Response ANQP-element and EBCS ANQP-element indicating the acceptance or rejection of the request to start transmitting each EBCS traffic stream indicated in the EBCS Content Request ANQP-element.

In one example, the EBCS AP may indicate that the EBCS STA or receiver may need to establish security with the EBCS AP before the EBCS STA or receiver may transmit a frame containing the EBCS Request ANQP element. Security between the EBCS AP and EBCS STA or receiver may be established by using pre-association Security Negotiation (PASN) or other type of security protocols. In one example, an EBCS AP may transmit a frame containing an EBCS Response ANQP-element to the EBCS STA or receiver in response to the received EBCS Request ANQP element, indicating that the EBCS STA or receiver may need to conduct PASN or other type of security with the EBCS AP first before sending another EBCS Request ANQP-element. In another example, an EBCS AP may indicate in any beacons, S1G beacons, probe response frames, FILS Discovery frames that it transmits that PASN or other type of security is needed prior to any negotiation or request for an EBCS traffic stream. An EBCS STA or receiver receiving such an indication, it may first establish security with the EBCS AP using PASN or other type of security, which may be indicated in a received frame, before it transmits any frames containing EBCS Content Request ANQP-element to that EBCS AP to request one or more EBCS traffic streams.

If the EBCS AP accepts a request for an EBCS traffic stream, it may include a Time To Termination subfield in the EBCS ANQP-element to indicate the time to termination for the EBCS traffic stream.

The EBCS AP may have the authority to determine the time to termination of the EBCS traffic stream. ANQP elements received from unassociated STAs are not protected and hence the EBCS AP may exercise caution in accepting certain requested durations. An EBCS AP may evaluate certain criteria before responding to the EBCS service request from an unassociated STA from which it receives an EBCS Request ANQP-element. Such criteria may include, but are not limited to, limiting the time duration and/or frequency of EBCS traffic stream requests. The evaluation of the criteria might be based on local policies installed at the EBCS AP, which is out of scope of this disclosure.

In another example, an EBCS STA or receiver that has registered for an EBCS traffic stream using an EBCS Content Request ANQP-element may de-register for the EBCS traffic stream when it no longer consumes the traffic stream. In order to achieve this, the EBCS STA or receiver may send a frame including an EBCS Content Request ANQP-element to the EBCS AP that is transmitting the EBCS traffic stream. The Broadcast Action bit in the EBCS Content Request Info Control subfield in the EBCS Content Request Info subfield including the content ID of the EBCS traffic stream for which the EBCS STA or receiver attempts to de-register may be set to 0.

In another example, an EBCS STA or receiver that consumes an EBCS traffic stream may de-register for the EBCS traffic stream when it no longer consumes the traffic stream. In order to achieve this, the EBCS STA or receiver may send a frame including an EBCS Content Request ANQP-element to the EBCS AP that is transmitting the EBCS traffic stream. The Broadcast Action bit in the EBCS Content Request Info Control subfield in the EBCS Content Request Info subfield including the content ID of the EBCS traffic stream for which the EBCS STA or receiver attempts to de-register may be set to 0.

An EBCS STA or receiver may combine registering for one or more EBCS traffic streams and de-registering for one or more EBCS traffic streams by sending one frame that includes one EBCS Content Request ANQP-element, in which one or more EBCS Content Request Info subfields include Broadcast Action set to 1 and one or more EBCS Content Request Info subfields contain Broadcast Action set to 0.

After receiving an EBCS Request ANQP-element from an unassociated EBCS STA or receiver, for example, the EBCS STA or receiver that registered for one or more EBCS traffic streams, with the Broadcast Action set to 0 in an EBCS Content Request Info subfield for one or more EBCS traffic streams, an EBCS AP may respond with EBCS Response ANQP-element with the EBCS Content Request Status set to 1 in the EBCS Content Response Info subfield including the content ID for the traffic stream for which the EBCS STA is requesting de-registration. The EBCS AP may continue to broadcast the EBCS traffic stream after an unassociated EBCS STA or receiver has de-registered for the EBCS traffic stream.

In another example, after receiving an EBCS Request ANQP-element from an unassociated EBCS STA or receiver, for example, the EBCS STA or receiver that registered for one or more EBCS traffic streams, with the Broadcast Action set to 0 in an EBCS Content Request Info subfield for one or more EBCS traffic streams, an EBCS AP may transmit an ACK frame. The EBCS AP may continue to broadcast the EBCS traffic stream after it has transmitted the ACK frame.

In yet another example, after receiving an EBCS Request ANQP-element from an unassociated EBCS STA or receiver, for example, the EBCS STA or receiver that registered for one or more EBCS traffic streams, with the Broadcast Action set to 0 in an EBCS Content Request Info subfield for one or more EBCS traffic streams, an EBCS AP may not respond regarding the EBCS traffic streams that the EBCS STA or receiver requests to be de-registered. The EBCS AP may continue to broadcast the EBCS traffic stream after an unassociated EBCS STA or receiver has de-registered for the EBCS traffic stream.

The EBCS AP, after receiving an EBCS Request ANQP-element from an unassociated EBCS STA or receiver, for example, the EBCS STA or receiver that registered for one or more EBCS traffic streams, with the Broadcast Action set to 0 in an EBCS Content Request Info subfield for one or more EBCS traffic streams, may terminate the transmission of the EBCS traffic streams.

Efficient time to termination negotiation procedures are discussed herein.

An EBCS STA that receives an EBCS Termination Notice frame may negotiate for the extension of an EBCS traffic stream if the EBCS traffic stream indicated in one of the EBCS Termination Information subfields terminates earlier than desired. If the EBCS STA negotiates the extension of the EBCS traffic stream, it may use the negotiation method indicated in the Negotiation Method subfield in the EBCS Termination Information subfield.

A Negotiation Method 1 subfield value means that an STA that is associated with a broadcaster AP can make an EBCS traffic stream request through EBCS Content Request Frames. A Negotiation Method 2 subfield value means that an EBCS traffic stream request made by an STA that is not associated with the broadcaster AP can be made using an EBCS Content Request ANQP element. Negotiation Method 2 also means that STAs that are associated with a broadcaster AP can make an EBCS traffic stream request either by an EBCS Content Request ANQP element or by using an EBCS Content Request Frame.

In embodiments, to request one or more EBCS traffic streams provided by an EBCS AP, with which an EBCS non-AP STA is associated, the STA may transmit an EBCS Content Request frame to the EBCS AP. To request one or more EBCS traffic streams that an EBCS AP has indicated require association, an unassociated EBCS non-AP STA may associate with the EBCS AP and subsequently transmit an EBCS Content Request frame. A request for one or more EBCS traffic streams that does not require association may also be included in the same EBCS Content Request frame. When requesting an EBCS traffic stream using an EBCS Content Request frame, an EBCS non-AP STA may request an EBCS traffic stream with a certain time to termination as indicated in the Requested Time To Termination field included in the EBCS Content Request frame. In addition, the STA may indicate the MAC address of the AP it is currently receiving the service from, using the Broadcaster MAC Address subfield. The non-AP STA may include in the Broadcaster MAC Address subfield in the EBCS Content Request frame the MAC address of the AP currently serving the EBCS traffic stream, which may differ from the AP receiving the request. This information may be used to distribute the EBCS load transmitted by different EBCS APs in a certain area.

After receiving an EBCS Content Request frame from an associated EBCS non-AP STA, an EBCS AP may respond with an EBCS Content Response frame. The status of the request for the EBCS traffic stream identified by a content ID is indicated by the EBCS Content Request Status subfield in the EBCS Content Response Info subfield containing the same content ID. If the EBCS AP indicates in the EBCS Content Response frame that the request for an EBCS traffic stream is successful, it may include a Time To Termination field to indicate the time to termination for the EBCS traffic stream. It may also include EBCS SP duration and the EBCS SP interval for the EBCS traffic stream in the EBCS Content Response frame.

An EBCS non-AP STA that receives an EBCS Content Response frame may negotiate for the extension of an EBCS traffic stream if the EBCS traffic stream indicated in one of the EBCS Response Info subfields terminates earlier than desired. The EBCS STA may negotiate the extension of the EBCS traffic stream by transmitting another EBCS Content Request frame to its associated AP by including a desired value in the Requested Time To Termination subfield in the EBCS Request Info subfield whose Content ID subfield corresponds to the EBCS traffic stream.

An EBCS non-AP STA that received an EBCS Termination Notice frame may negotiate for the extension of an EBCS traffic stream using an EBCS Content Request frame if the EBCS traffic stream indicated in one of the EBCS Termination Info subfields terminates earlier than desired and the Negotiation Method indicated in the same EBCS Termination Info subfield is set to 1 or 2. The EBCS STA may negotiate the extension of the EBCS traffic stream by transmitting an EBCS Content Request frame to its associated AP by including a desired value in the Requested Time To Termination subfield in the EBCS Request Info subfield whose Content ID subfield corresponds to the EBCS traffic stream.

In embodiments, an unassociated EBCS STA may transmit an EBCS ANQP-element to an EBCS AP to register for one or more EBCS traffic streams when that AP has indicated that it does not require an association. When registering for an EBCS traffic stream using an EBCS Request ANQP-element, an EBCS STA may request a specific time to termination using the Requested Time To Termination subfield and may indicate the MAC address of the AP it is currently receiving the service from using the Broadcaster MAC Address subfield. The Broadcaster MAC Address subfield allows the non-AP STA to provide the MAC address of the AP currently serving the EBCS traffic stream, which might not be the same as the one receiving the request. This information might be used to distribute the EBCS load transmitted by different EBCS APs in a certain area.

After receiving an EBCS Request ANQP-element from an unassociated EBCS STA, an EBCS AP may respond with EBCS Response ANQP-element and EBCS ANQP-element indicating the acceptance or rejection of the request to start transmitting each EBCS traffic stream indicated in the EBCS Request ANQP-element. If the EBCS AP accepts a request for an EBCS traffic stream, it may include a Time To Termination subfield in the EBCS ANQP-element to indicate the time to termination for the EBCS traffic stream.

An unassociated EBCS STA that received an EBCS Termination Notice frame may negotiate for the extension of an EBCS traffic stream using an EBCS Content Request ANQP-element if the EBCS traffic stream indicated in one of the EBCS Termination Info subfields terminates earlier than desired and the Negotiation Method indicated in the same EBCS Termination Info subfield is set to 2. The EBCS STA may negotiate the extension of the EBCS traffic stream by transmitting an EBCS Content Request ANQP-element to the EBCS AP from which the EBCS Termination Notice frame is received by including a desired value in the Requested Time To Termination subfield in the EBCS Request Info subfield whose Content ID subfield corresponds to the EBCS traffic stream.

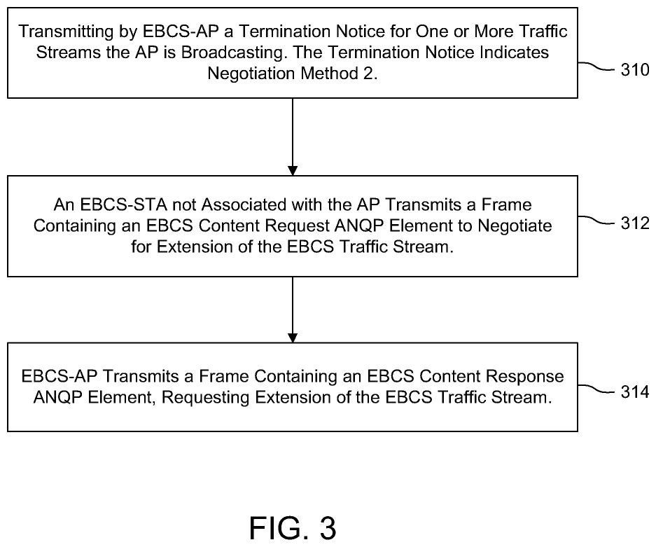

With reference to FIG. 3, at 310, an EBCS-enabled AP may transmit a termination notice for one or more traffic streams the AP is broadcasting, the termination notice indicating negotiation method 2. At 312, an EBCS-STA not associated with the AP may transmit a frame containing an EBCS Content Request ANQP element to Negotiate for Extension of the EBCS Traffic Stream. At 314, the EBCS-AP may respond by transmitting a Frame Containing an EBCS Content Response ANQP element granting extension of the EBCS traffic stream.

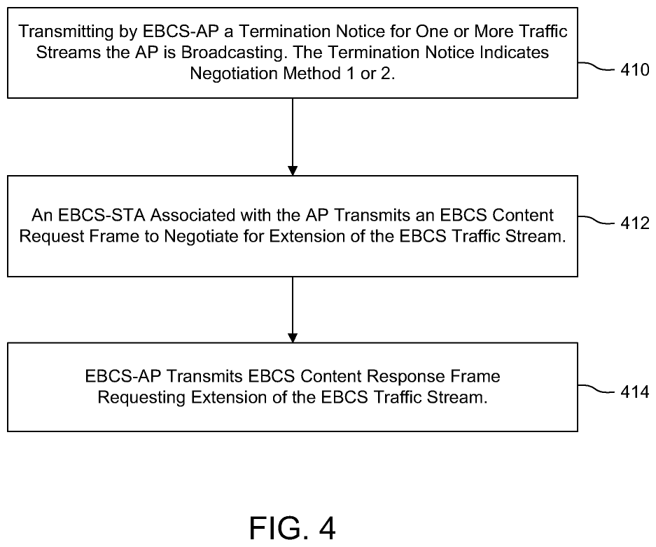

With reference to FIG. 4, at 410, an EBCS-enabled AP may transmit a termination notice for one or more traffic streams the AP is broadcasting, the termination notice indicating negotiation method 1 or 2. At 412, an EBCS-STA that is associated with the AP may transmit a frame containing an EBCS content request frame requesting extension of the EBCS Traffic Stream. At 414, the EBCS-AP may respond by transmitting a Frame Containing an EBCS content response frame granting extension of the EBCS traffic stream.

The EBCS AP may follow the EBCS termination notice procedure (e.g., EBCS termination notice procedure) prior to terminating the transmission of the EBCS traffic streams.

Embodiments for efficient AIML Capabilities Discovery, for example, through ANQP, are described herein. A STA may use ANQP to retrieve information on aspects of the network and available services. However, there are currently no ANQP elements specified to support AIML capabilities discovery. Hence there is a need for a set of ANQP elements to support a STA ability to discover AIML capabilities that are available from an AP or a network that is reachable via the AP. ANQP-elements may include query, response, and informational elements. These elements may be transmitted pre-association via the Generic Advertisement Service (GAS) protocol, included in an AP beacon, or transmitted post-association to enable the discovery of AIML capabilities or availability.

Embodiments for AIML Query/Response via GAS are described herein. A requesting STA may send an AIML ANQP query via a GAS Query Request to another STA (e.g., the queried STA, typically this will be an AP that is connected to a network). The AIML query may be defined in an AIML element or a set of AIML elements. The AIML element may be sent in a GAS Query Request alone or may be one of several ANQP elements sent in the GAS Query. The AIML element may include the fields describing aspects of the AIML services desired by the requesting STA that may be provided by or via the queried STA. The AIML element may include the following fields, but are not limited to: an info ID field indicating that this is an AIML query, a length field, AIML service type field, AIML learning type field, AIML data field, AIML coefficient field, and additional AIML description and service description fields. The info ID field may include a value that will identify the ANQP element as an AIML element (e.g. 287). The length field may include a value providing the field length. The AIML service type field may include a value that will indicate the type of AIML/MIML service (e.g., AIML based location service (001), AIML wireless media (WM) management (002), AIML beam forming (003), etc.). The AIML learning type field may include a value that will indicate the learning type used by the AIML (e.g., supervised (001), unsupervised (002), reinforced (003), federated (004), etc.) The AIML data field may provide an indication that the STA has data to provide to support the AIML service, the type of data it has or the type of data that it is requesting. The AIML coefficient field may include a request for AIML coefficients from the AIML service, or provide coefficients the STA is currently using. Additional fields may be defined as required to request/provide AIML information. An AIML query may also use a Vendor Specific ANQP-element and, or may be made by other ANQP elements with AIML fields.

The AIML ANQP GAS query to an ANQP server via the queried STA may generate an AIML ANQP GAS response. An AIML ANQP GAS response may contain the requested information in an AIML element or set of AIML elements. The AIML element may include the same fields as the AIML element used in the AIML ANQP GAS request, a subset of the fields, or additional fields.

Embodiments for AIML information via ANQP Advertisement are described herein. An AP may provide AIML information by the ANQP advertisement protocol. To do so the AP may provide a AIML element or elements in a ANQP Advertisement Protocol element in a Beacon or Probe Response frame transmitted by the AP. A STA seeking AIML services may receive the transmitted Beacon or Probe Response frames and obtain the advertised information about the AIML services provided by or available through the AP. A STA seeking AIML services may also send a Probe Request requesting AIML services to an AP, the Probe Request may contain an AIML element (as described above), or other content describing the AIML information being requested.

Embodiments for AIML information via ANQP query are described herein. A STA associated with an AP may request AIML information by a ANQP request to a service information registry (SIR). To do so the STA may send an ANQP request including an AIML element or elements to the SIR. The SIR may respond with an ANQP response including the requested information or indicating that the information is not available.

Embodiments for AIML information via pre-association discovery (PAD) are described herein. A STA may use PAD to discover APs that provide AIML services. The STA may use unsolicited PAD or solicited PAD to obtain information that an AP offers AIML services. Once a STA is aware that an AP offers AIML services via PAD, the STA obtain additional AIML information by ANQP, direct communication with the AIML service, or by using other network services.

Although the features and elements of the present invention are described in the preferred embodiments in particular combinations, each feature or element can be used alone without the other features and elements of the preferred embodiments or in various combinations with or without other features and elements of the present invention.

Although the solutions described herein may reference IEEE 802.11 specific protocols, it is understood that the solutions described herein are not restricted to this scenario and are applicable to other wireless systems as well.

Although SIFS is used to indicate various inter frame spacing in the examples of the designs and procedures, all other inter frame spacing such as RIFS, AIFS, DIFS or other agreed time interval could be applied in the same solutions.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for use in a station (STA), the method comprising:
receiving an Enhanced Broadcast Services (EBCS) termination notice from an EBCS access point (AP) for one or more ECBS traffic streams transmitted by the AP; and
based on a determination that the termination notice indicates an EBCS traffic stream of shorter duration than desired by the STA,
transmitting, by the STA to the EBCS AP, when the STA is associated with the AP and the termination notice indicates a negotiation method type 1 or type 2 is permitted, an EBCS content request frame requesting extension of the EBCS traffic stream.

2. The method of claim 1, wherein the EBCS content request frame includes a desired value in a requested time to termination subfield of the EBCS content request.

3. The method of claim 1, wherein the EBCS content request frame comprises a content ID subfield corresponding to the EBCS traffic stream.

4. The method of claim 1, wherein a type I negotiation method includes a request through an EBCS content request frame.

5. The method of claim 1 any of the preceding claims, wherein a type 2 negotiation method incudes a request through an EBCS content request frame or a request through an EBCS content request ANQP element.

6. A method for use in a station (STA), the method comprising:
receiving an Enhanced Broadcast Services (EBCS) termination notice from an EBCS access point (AP) for one or more ECBS traffic streams transmitted by the AP; and
based on a determination that the termination notice indicates an EBCS traffic stream of shorter duration than desired by the STATE,
transmitting, by the STA to the EBCS AP, when the STA is not associated with the AP and the termination notice indicates a negotiation method type 2 is permitted, an EBCS content request frame including an access network query protocol (ANQP) element requesting extension of the EBCS traffic stream.

7. The method of claim 6, wherein the ANQP element includes a desired value in a requested time to termination subfield of the EBCS content request.

8. The method of claim 6, wherein the EBCS content request frame comprises a content ID subfield corresponding to the EBCS traffic stream.

9. The method of claim 6, wherein a type 2 negotiation method includes a request through an EBCS content request ANQP element.

10. A station (STA) comprising:
a receiver;
a transmitter; and
a processor, wherein the receiver, the transmitter and the processor are configured to:
receive an Enhanced Broadcast Services (EBCS) termination notice from an EBCS access point (AP) for one or more ECBS traffic streams transmitted by the AP; and
based on a determination that the termination notice indicates an EBCS traffic stream of shorter duration than desired by the STA,
transmit to the EBCS AP, when the STA is associated with the AP and the termination notice indicates a negotiation method type 1 or type 2 is permitted, an EBCS content request frame requesting extension of the EBCS traffic stream.

11. The STA of claim 10, wherein the EBCS content request frame includes a desired value in a requested time to termination subfield of the EBCS content request.

12. The STA of claim 10, wherein the EBCS content request frame comprises a content ID subfield corresponding to the EBCS traffic stream.

13. The STA of claim 10, wherein a type 1 negotiation method includes a request through an EBCS content request frame.

14. The STA of claim 10, wherein a type 2 negotiation method incudes a request through an EBCS content request frame or a request through an EBCS content request ANQP element.
